(19) United States
(12) Patent Application Publication
(10) Pub. No.: US 2023/0397974 A1
(43) Pub. Date: Dec. 14, 2023

(54) METHOD FOR VERTICAL PERIODONTAL AUGMENTATION

(71) Applicant: PerioTech, LLC, Palm Beach Gardens, FL (US)

(72) Inventor: Robert A. HOROWITZ, Armonk, NY (US)

(21) Appl. No.: 17/746,332

(22) Filed: May 17, 2022

(51) Int. Cl. A61C 8/02

(52) U.S. Cl. CPC A61C 8/0006

(57) ABSTRACT

A novel method incorporates ground dentin as a bioactive bone graft. An extracted tooth is processed into a sterilized particulate bone replacement graft material. While the graft material is being processed and sterilized, the roots of the adjacent tooth with periodontal disease are cleaned of physical debris. The outer smear layer is removed, exposing the dentin tubules and collagen by treatment with EDTA. The processed, sterilized dentin is then used alone or mixed with mineralized allograft and formed into a PRF block to help it maintain volumetric shape during the initial healing process. After insertion into the surgical site, it is covered by a barrier, preferentially a bioactive amnion/chorion barrier. The flaps are then sutured to attempt to obtain primary closure over the graft and barrier.

### BACKGROUND

### Field

The present disclosure relates to periodontal and oral surgery. Aspects of the disclosure describe methods for the treatment of alveolar crestal bone loss for the horizontal restoration of alveolar bone height.

### Background

Regeneration of degraded periodontal ligament and alveolar bone is the most important goal in periodontal surgical treatments. Frequently, periodontal disease can progress to the stage requiring tooth extraction. Extraction of teeth involves tissue trauma and creates a void in the maxillary or mandibular alveolar bone, which result in remodeling of the extraction site as well as neighboring intact teeth. Neighboring intact teeth can be destabilized by the resorption of adjacent alveolar bone and reformation associated with the extraction of a neighboring tooth. The loss of vertical bone height across the alveolar ridge at a tooth affected by periodontal disease and/or adjacent to a tooth extraction site is known as horizontal bone loss.

Various approaches have been attempted to mitigated supra-alveolar bone loss. The use of grafts to augment the alveolar bone has met with varying degrees of success, but horizontal bone loss has been a particularly difficult challenge. See Jayakumar et al., “Horizontal alveolar bone loss: A periodontal orphan,” J Indian Soc Periodontol. 2010 July-September; 14(3): 181-185.

Grafts to fill the socket left by an extraction have been employed for decades. Schallhorn et al. introduced the use of autogenous hip marrow grafts from the iliac crest during the late 1960's to treat furcation and intrabony defects. See Schallhorn et al., “Iliac transplants in periodontal therapy,” J Periodontol 1970; 41:566-80 and Elsalanty M. E. et al., “Grafts in craniofacial surgery,” Craniomaxillofac Trauma Reconstr 2009; 2:125-34. While gains in crestal bone was reported following the treatment of intrabony defects with hemopoietic marrow grafts, one major problem of using hemopoietic cells is that they contain monoblastic precursors to osteoclasts, cells which resorb bone. The marrow was often so active that resorption of neighboring tooth roots resulted from its use. Additional disadvantages include the added expense, time, the involvement of a secondary surgical site and surgical expertise required for harvesting iliac crest marrow.

The prior art includes reports of dentin grafting for preservation of volume in extraction sockets. Extraction sockets packed with graft material tend to lead to less overall bone loss than an unpacked socket allowed to heal without treatment.

Regenerative treatments frequently require modification and decontamination of diseased root surfaces. These are required to foster biocompatibility for new attachment of new tissue structures. One additional factor important for tissue restoration is the removal of plaque, calculus and various cytotoxic materials from a diseased root surface. Root planing is frequently employed to remove diseased material to mitigate pathologic changes to the root surface that could ultimately affect the outcome of reconstructive treatment. Periodontally disease results in more mineralized surfaces that resorb more substances such as calcium, phosphorous and fluoride. Bacteria is another major concern, as their bioactivity creates further degradation as well as a hostile environment for the beneficial cells of repair at the root surface. In addition, periodontally diseased cementum can lose collagen fibers resulting in further degradation and instability. A further complication is that after root planing, treated root surfaces will experience the formation of the so-called smear layer, which can frustrate new attachment of periodontal and/or bony tissues and inhibit fibroblast and osteoblast proliferation.

Smear layers form on hard tissues after root planing or other mechanical treatments, such as cutting. The smear layer is thin (1-2 microns) and formed of various denatured cutting debris mixed with bacteria and other compounds. It is tenacious and results in cutting debris being forced into the dental tubules forming so-called smear plugs, which further decrease dentin permeability and also affect surface wettability, interfering with grafting, bonding and new tissue formation.

### SUMMARY

The present disclosure describes a method for the vertical augmentation of the height of the alveolar bone adjacent to or horizontal from an alveolar defect or socket.

According to exemplary embodiments of the disclosure, a method for periodontal and oral surgery includes identifying a first location along the alveolar ridge of a patient for dimensional augmentation, opening the gum of a patient at a second location adjacent to the first location; packing a graft material comprising dentin into the socket or defect; and covering the graft material with a membrane. Advantageously and surprisingly, alveolar height is preserved or augmented horizontally.

According to further exemplary embodiments of the disclosure, a method for vertically augmenting alveolar bone lateral to a treatment site includes identifying a first location along the alveolar ridge of a patient for dimensional augmentation, packing a graft material comprising ground dentin at a second location laterally adjacent to the first location. Advantageously and surprisingly, alveolar height is preserved or augmented at the first location.

### BRIEF DESCRIPTION OF DRAWING(S)

The drawings are not necessarily to scale or exhaustive. Instead, emphasis is generally placed upon illustrating the principles of the inventions described herein. The accompanying drawings, which are incorporated in and constitute a part of this specification, illustrate several embodiments consistent with the disclosure and together with the description, serve to explain the principles of the disclosure. The patent or application file contains at least one drawing executed in color. Copies of this patent or patent application publication with color drawing(s) will be provide by the Office upon request and payment of the necessary fee. In the drawings:

FIG. 1 is a radiograph of an exemplary patient described in Example 1.

FIG. 2 is a CBCT image of the exemplary patient described in Example 1.

FIG. 3 is a photographic view of the dental arch of the patient described in Example 1 during an exemplary procedure.

FIG. 4 is a photographic view of the dental arch of the patient described in Example 1 at a later stage than FIG. 3 of an exemplary procedure.

FIG. 5 is a photographic view of the dental arch of the patient described in Example 1 at a still later stage than FIG. 4 of an exemplary procedure.

FIG. 6 is a photographic view of the dental arch of the patient described in Example 1 showing placement of a barrier.

FIGS. 7A and 7B are follow-up radiographic images of the patient described in Example 1.

FIG. 8 is an annotated follow-up radiographic image of the patient described in Example 1.

FIG. 9 is a radiographic image of the lower front dentition of the patient described in Example 2.

FIG. 10 is an annotated follow-up radiographic image of the patient described in Example 2.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

According to exemplary embodiments of the disclosure, a patient was subject to administration of local anesthetic. The tooth is extracted and then processed for preparation of the bone replacement graft material. According to an exemplary embodiment, the extracted tooth was then ground and processed using a dental milling apparatus sold under the brand SMART DENTIN GRINDER (available from KometaBio, Fort Lee, NJ). The tooth is ground into small and large particles. As is generally known in the art, ground autologous dentin contains bioactive materials.

According to further aspects of the disclosure, while the autogenous dentin was being processed, a flap was elevated around the areas of the adjacent tooth where the periodontal defect had created bone loss. The socket and adjacent root surfaces were debrided and cleared of debris. According to still further exemplary aspects of the disclosure, the exposed affected portions of the tooth were root planed with hand and/or ultrasonic and/or piezoelectric instrumentation in preparation for graft placement.

The smear layer can next be removed from the root-planed surface. This can be accomplished mechanically, for example using water jetting, or chemically using, for example, a chelating agent. According to an illustrative embodiment of the disclosure, all exposed areas were treated with 10% Ethylenediaminetetraacetic Acid (EDTA) Solution as a partial demineralization agent and smear layer remover, exposing the dentin tubules. The autologous ground dentin can be inserted into the deficient area alone, or in an exemplary embodiment in a leucocyte- and platelet-rich fibrin (L-PRF) block to help maintain volumetric shape during the initial healing process. In an illustrative embodiment, the ground dentin can be mixed with mineralized allograft if more volume is required. In an exemplary embodiment, the graft mixture was then placed filling the extraction socket and around the adjacent tooth or teeth to the level of the ideal alveolar crest or cementoenamel junction (CEJ). Next, a barrier is placed around and over the grafted area and tucked under the flap margins. In an illustrative embodiment of the disclosure, a dehydrated human deepithelialized amnion-chorion membrane sold under the trade name BIOXCLUDE (available from Snoasis Medical, Golden, CO) served as a barrier. The flaps are then sutured in an attempt to obtain primary closure over the graft and barrier. In an exemplary embodiment, although primary closure is not required, sutures were placed to secure the soft tissue flaps in place.

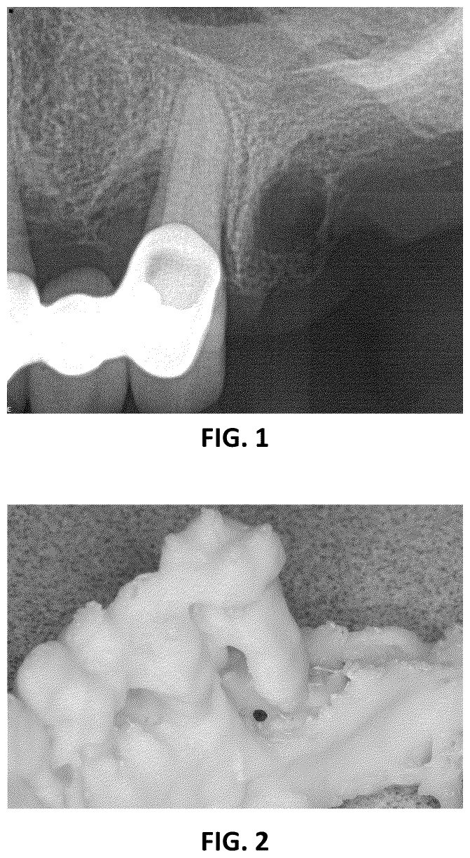

A periapical radiograph is taken to document the level of graft placement. An exemplary patient radiograph discussed in Example 1 appears as FIG. 1.

Over time, the barrier becomes absorbed into the soft tissues. The autogenous dentin recruits endothelial and osteoblast cells. Over time the graft completely blends with the surrounding host bone and no differentiation is be noted between the native bone and previously placed graft radiologically. Initially, Type I macrophages (M1) are present; and over time owing to the growth factors present in dentin, modulation to Type II macrophages (M2), changing their activity from resorption to bone regeneration. See Nasizrade et al., “Acid Dentin Lysate Modulates Macrophage Polarization and Osteoclastogenesis In Vitro,” Materials 2021, 14, 6920.

In an exemplary embodiment, periodontal probing can be performed within 4-6 months.

Advantageously, vertical bone growth is achieved on the adjacent tooth. To Applicant's knowledge, this has not been achievable predictably in the prior art. Clinically at-risk, unstable and even hopeless teeth can be advantageously rescued by restoring or augmenting the alveolar bone as described herein.

### Example 1

FIG. 1 is a radiograph taken from a patient presenting with severe periodontal disease threatening an intact tooth adjacent to an extraction socket. Loss of the intact tooth would threaten the fixed partial denture (FPD) visible in the radiograph. Loss of the FPD would compromise arch integrity in this patient because of other issues within the arch, including a questionable root canal. The patient refuses removable partial denture (RPD) as a remedy. Sinus perforation was discovered as seen in FIG. 2, and cone-beam computed tomography (CBCT) confirmed infected sinus.

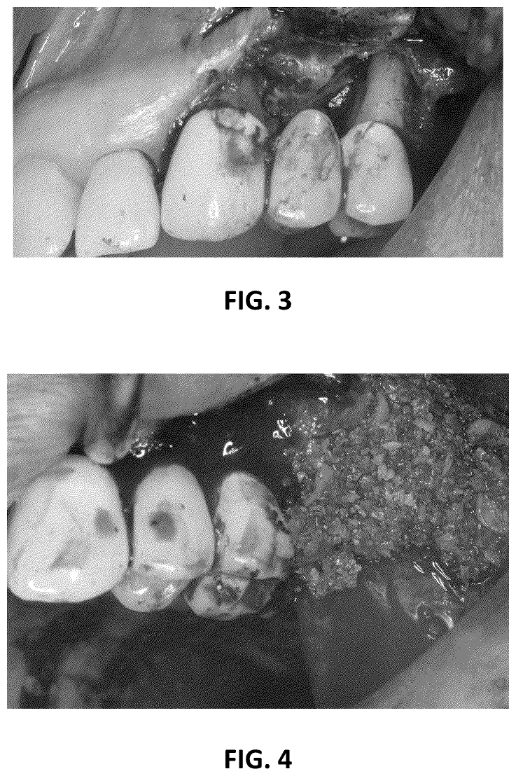

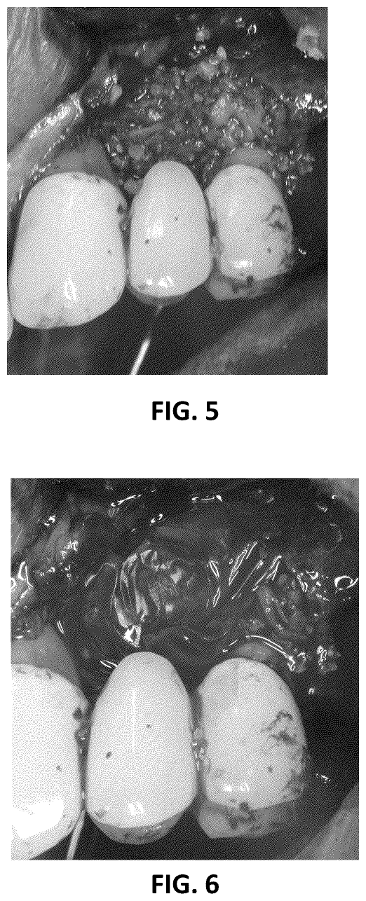

As shown in FIG. 3, a flap was created to expose the compromised adjacent roots. As described herein, autologous dentin is made into an L-PRF block and packed around the compromised roots to stabilize the FPD as shown in FIG. 4. Ground dentin PRF block was additionally packed into the socket underlying the FPD, as shown in FIG. 5, and covered by a barrier as described above. A barrier was also placed over the oro-antral communication to help seal the perforation.

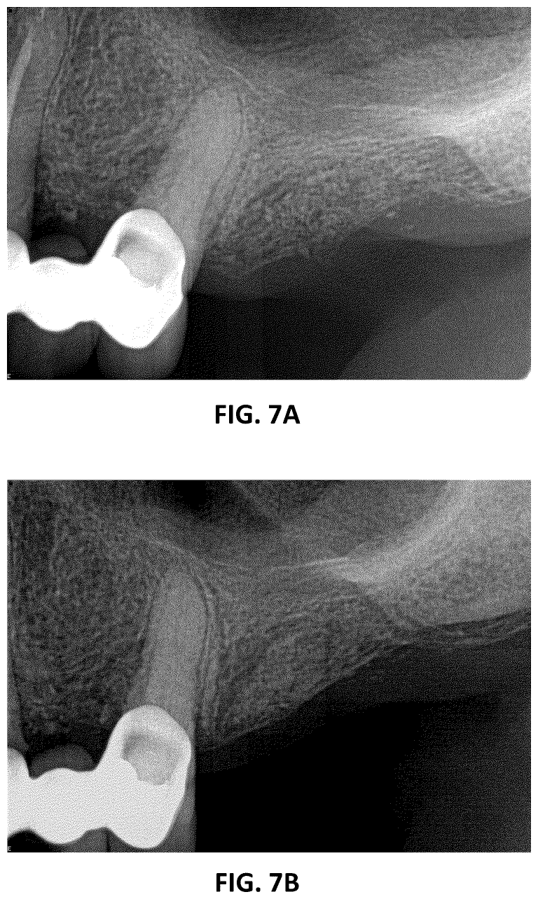

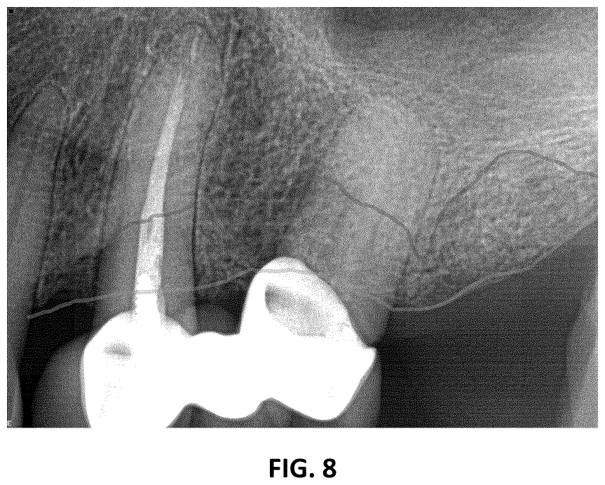

Follow-up radiographs taken at 6 months and 12 months appear as FIGS. 7A and 7B, respectively. These images show excellent augmentation and stabilization of the graft. Follow up exams confirmed resolution of periodontal disease and excellent prognosis. Augmentation of the alveolar ridge is depicted in FIG. 8, showing the initial level (red) and augmented level (green). Augmentation was measured to be 6-9 mm in the vertical dimension on the adjacent teeth.

### Example 2

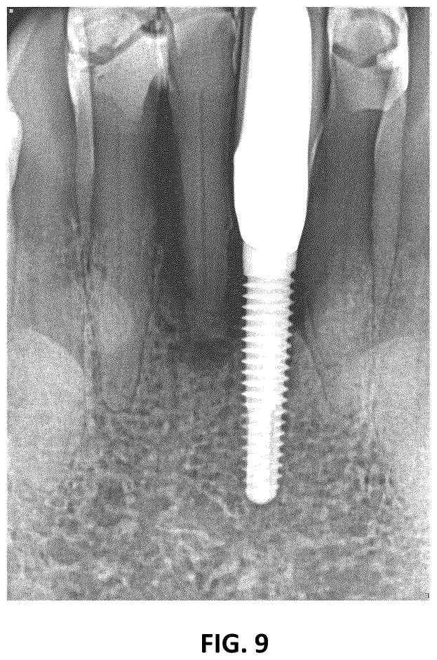

FIG. 9 is a radiograph taken from a patient presenting with severe periodontal disease threatening an implant and several adjacent teeth of the lower arch. Risk factors included root proximity, smoking, vertical bone loss with no adjacent blood supply, and questionable adjacent teeth. The implant was at risk, and all three remaining natural lower incisors were severely compromised.

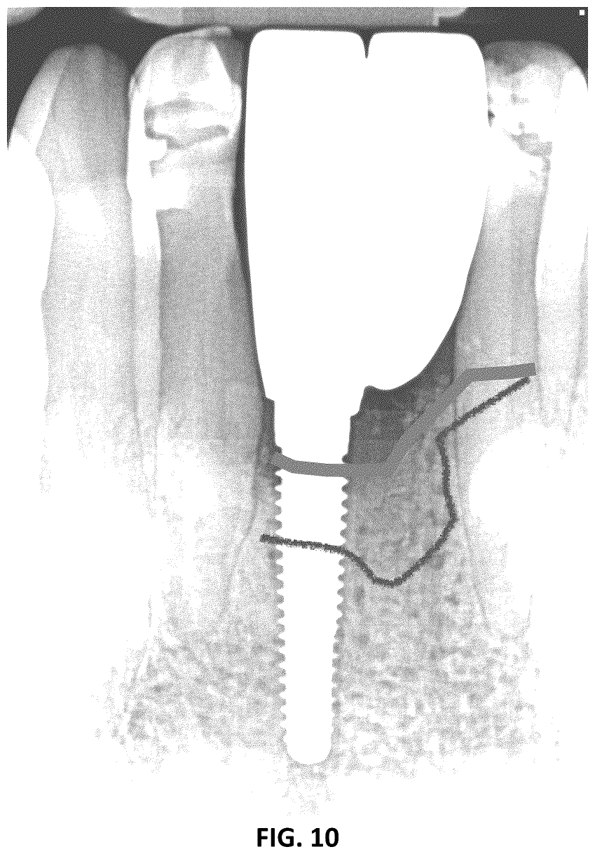

An atraumatic extraction was performed on the central incisor neighboring the implant. The compromised implant and the extraction socket were treated with ground dentin and L-PRF block as described herein, and barrier was applied. Vertical augmentation was achieved not only preserving the viability of the implant post, but also permitting a lateral prosthesis to be added to the primary prosthesis. Follow up exams confirmed resolution of periodontal disease and excellent prognosis. FIG. 10 is an 18-month follow-up radiographic image showing the vertical augmentation of the alveolar ridge at the socket and horizontally at the implant with the initial level (red) and augmented level (green). The procedure stabilized the arch and allowed the preservation of two natural (lateral) incisors and two prosthetic (central) incisors attached to a single implant post. Augmentation was measured to be 6 mm vertically on the implant, 3-5 mm on the adjacent tooth surfaces.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

Other embodiments will be apparent from consideration of the specification and practice of the embodiments disclosed herein. It is intended that the specification and examples be considered as example only, with a true scope and spirit of the disclosed embodiments being indicated by the following claims.

1. A method for oral surgery, comprising:
identifying a first location along the alveolar ridge of a patient for dimensional preservation;
opening the gum of a patient at a second location, adjacent to the first location, having a socket and/or alveolar defect;
packing a graft material comprising dentin into the socket and/or alveolar defect;
covering the graft material with a membrane;
wherein vertical bone height is preserved across the alveolar ridge at the first location.

2. The method of claim 1, wherein the graft material comprises autologous dentin.

3. The method of claim 2, further comprising the step of grinding one or more autologous teeth.

4. The method of claim 1, wherein the first location is an alveolus directly adjacent to an alveolus at the second location.

5. (canceled)

6. The method of claim 1, wherein the step of opening the gum includes forming a periodontal flap.

7. The method of claim 1, further comprising the step of preparing the second location prior to the packing step.

8. The method of claim 7, wherein the step of preparing the second location comprises root planing.

9. The method of claim 1, wherein the first location is an implant site.

10. The method of claim 1, wherein the first location corresponds to a questionable tooth.

11. The method of claim 1, wherein the membrane in the covering step is amnion-chorion membrane.

12. The method of claim 1, wherein the graft comprises L-PRF block.

13. A method for vertically augmenting alveolar bone lateral to a treatment site, comprising:
identifying a first location along the alveolar ridge of a patient for dimensional augmentation,
packing a graft material comprising ground dentin at a second location laterally adjacent to the first location;
wherein
vertical bone height is augmented across the alveolar ridge at the first location.

14. The method of claim 13, wherein dentin graft material comprises autologous dentin.

15. The method of claim 14, further comprising the step of grinding one or more autologous teeth.

16. The method of claim 13, wherein the first location is an alveolus directly adjacent to an alveolus at the second location.

17. The method of claim 13, wherein the second location is at a defect or extraction socket.

18. The method of claim 13, further comprising the step of forming a periodontal flap.

19. The method of claim 13, further comprising the step of preparing the second location prior to the packing step.

20. The method of claim 19, wherein the step of preparing the second location comprises root planing.

21. The method of claim 13, wherein the first location is an implant site.

22. The method of claim 13, wherein the first location corresponds to a questionable tooth.

23. The method of claim 13, wherein the membrane in the covering step is amnion-chorion membrane.

24. The method of claim 13, wherein the graft comprises L-PRF block.

25. (canceled)
